(19) United States
(12) Patent Application Publication
(10) Pub. No.: US 2014/0296472 A1
(43) Pub. Date: Oct. 2, 2014

(54) PROCESS FOR THE PREPARATION OF POLYAMIDES

(71) Applicant: INVISTA North America S.a r.l., Wilmington, DE (US)

(72) Inventor: Bryan Dinesh Kaushiva, Wakefield (GB)

(73) Assignee: INVISTA North America S.a r.l., Wilmington, DE (US)

(21) Appl. No.: 14/360,139

(22) PCT Filed: Nov. 27, 2012
(86) PCT No.: PCT/US2012/066603

§ 371 Date: May 22, 2014

Related U.S. Application Data
(60) Provisional application No. 61/566,886, filed on Dec. 5, 2011.

(51) Int. Cl. C08G 69/04

(52) U.S. Cl. CPC C08G 69/04
USPC 528/335

(57) ABSTRACT

The disclosures herein relate to a process for making polyamides from stoichiometrically imbalanced mixtures. This process includes the production and subsequent use of solidified stoichiometrically imbalanced components comprising mixtures of diacids and diamines. This stoichiometric imbalance is defined by a component molar ratio equal to moles of dicarboxylic acid units divided by moles of diamine units; and wherein this molar ratio is different from unity. This process comprises steps of: a) forming an acid-rich solidified first component in a dry or moisture containing state by; b) contacting at least a dicarboxylic acid with at least a diamine in a molar ratio of greater than 1:1; c) forming an amine-rich solidified second component in a dry or moisture containing state by; d) contacting at least a dicarboxylic acid with at least a diamine in a molar ratio of less than 1:1; e) contacting the acid-rich first component with the amine-rich second component in a molten state or a solution state and f) forming a first composition having a composition molar ratio g) such that a total dicarboxylic acid content and a total diamine content, supplied by said first and second components, is from about 0.95 to about 1.05; h) heating the first composition with agitation in the molten state and under pressure to a sufficiently high temperature for a polyamidation reaction to and subsequently, i) forming a second composition comprising a polyamide.

### RELATED APPLICATION

This application claims benefit to Provisional Application No. 61/566,886 filed Dec. 5, 2011 which is herein incorporated by reference in its entirety.

### FIELD OF THE INVENTION

The disclosures herein relate to a method for the production of polyamides having the benefit of lower energy requirements, lower thermal degradation, and greater compositional flexibility. More particularly these disclosures relate to processes of mixing and staging dicarboxylic acids with diamines and ultimately to the preparation of high molecular weight polyamides. In addition, these disclosures relate to the preparation of solid intermediate products of diamine and diacid blends adapted for storage and subsequent polyamidation at later times.

### BACKGROUND OF THE INVENTION

There are several disadvantages to the use of aqueous nylon salt solutions. The first is that the temperature and pressure required to stabilize the salt solutions increases exponentially with concentration. Reducing the amount of water therefore creates a trade-off with the cost and instability of managing a higher temperature and pressure storage process. Another disadvantage is the cost associated with handling large amounts of water. Storage vessels have to be larger and reactor batch yields have to be smaller as the amount of water is increased. Amidation itself is endothermic as energy is absorbed to remove the water produced in the reaction, and adding water to create the initial salt solution only increases the underlying energy requirement. Holding the solutions at high temperatures during storage and concentration also increases the risk of thermal degradation. Finally, the diamines used frequently have vapor pressures such that a portion of the diamine is lost to vaporization during the removal of water. Workers have sought to mitigate such disadvantages by exploiting the properties of deliberately imbalanced mixtures ahead of a balancing stage before or during polyamidation.

The disclosures of U.S. Pat. No. 4,131,712, herein incorporated by reference in its entirety, teaches that the melting point of aliphatic diamines and aliphatic diacids exhibit a peak at stoichiometric balance and a eutectic point exists for some blends. Based on that property, a process is disclosed that utilizes two imbalanced streams. A diacid-rich mixture is prepared wherein the total diacid to total diamine mole ratio is from about 1.5:1 to 9:1. A diamine-rich mixture is also prepared wherein the total diamine to total diacid mole ratio is greater than 1.5:1 and may also be pure diamine. The molten diamine-rich feed is then added to the molten diacid-rich mixture under good agitation. The temperature is increased to distill off the water and drive polyamidation while also preventing crystallization, and this process may lead finally to a balanced polymer wherein the mole ratio of total diacid to total diamine is within the range of 0.95 to 1.05. Depending on the moisture of the starting raw materials, this process may be described as largely anhydrous and thus avoids some of the disadvantages previously described. This process, however, does not address the problem of diamine volatility. In order to prevent solidification, the temperature is increased throughout this process during the feed of the diamine-rich mixture, and as the boiling point of the diamine is approached or surpassed this leads to increasingly fast diamine vaporization. A process is therefore needed which addresses the resulting difficulty in controlling final molar balance within a targeted range.

The disclosures of U.S. Pat. No. 4,438,257, herein incorporated by reference its entirety, teach an anhydrous polyamidation approach wherein the diamine is added to a molten diacid as the temperature is raised in two steps. This process manages diamine loss in two ways. The first is to specify that the diamine component must be at least 70 mol % m-xylylenediamine. M-xylylenediamine boils at 265° C. under atmospheric conditions, whereas hexamethylenediamine boils at 205° C., and this difference leads to lower diamine losses under this process. The second mitigation is to use a partial condenser to recycle recovered diamine back to the reactor while allowing for the removal of water. Restricting compositions to higher boiling diamines such as m-xylylenediamine makes this process uneconomical when compared to much less expensive but more volatile diamines. It would also be uneconomical to construct a condenser large enough to meet the reflux volume required for a system based on higher amounts of more volatile diamines such as hexamethylenediamine. As the temperature is raised during the synthesis, the residence time of free diamine in the liquid phase becomes continually shorter and this leads to disadvantageously long cycle times for completing the polyamidation. Changes to this process are elaborated in the disclosures found in U.S. Pat. Nos. 6,489,435B2; 6,559,273B2; 6,657,037B2 and 7,138,482B2 incorporated by reference in their entirely. Throughout these refinements, however, the restriction to the use of high-boiling diamines and the use of the diamine reflux column persist. A process is therefore needed which avoids these various shortcomings and provides balanced polyamides based on economical compositions and processes.

U.S. Pat. No. 5,674,974, incorporated by reference in its entirety, teaches that diamine vapor is completely and rapidly absorbed in highly acid-rich mixtures and at relatively lower temperatures. It then discloses a continuous counter-current polyamidation reactor system that it claims minimizes diamine losses by exploiting this property. Molten adipic acid or molten acid-rich feeds are fed into the top stage of a distillation column. Hexamethylenediamine is fed as a vapor into the lower stages of the column. As the diamine rises through the column it is progressively absorbed by each higher stage. Each higher stage is more acid-rich due to the counter-current flow of the system leading to the top stage which is the most acid-rich, and it is described as scrubbing out the remaining diamine vapor such that less than 100 ppm of diamine escapes the process. The process disclosed is largely anhydrous and so avoids the costly removal of water. Near-infrared is disclosed as the primary technique for controlling the balance of both the acid-rich feed preparation tank and that of the polyamidation reactor. This process requires the construction of entire facilities for both the acid-rich feed preparation and the reactor. A process is therefore needed which requires lower capital investment while achieving the benefits of avoiding solvation water.

U.S. Pat. No. 5,731,403, incorporated by reference in its entirety, teaches that mixtures at intermediate degrees of dehydration have usefully lower melting points than their fully dehydrated equivalents. It is reported that in an intermediate degree of dehydration, molten diacid rich and molten diamine rich components can be mixed to stoichiometric balance at temperatures below the melt temperature of the balanced salt (e.g., 195° C. for nylon 6,6 salt). It is taught that dehydration is substantially avoided at these lower temperatures such that the mixtures are stable for usefully long periods both in their molten state and intermediate degree of dehydration. The lower temperatures are desirable as a means of reducing diamine losses through vaporization. A process is thereby disclosed that reports substantially avoiding diamine evaporation by initially mixing a solid or molten acid-rich component with a molten diamine component at temperatures below the melting temperature of a fully dehydrated mixture and—after stoichiometric balance is achieved—then heating the mixture to drive polyamidation. The diacid-rich mixture claimed consists of adipic acid and hexamethylenediamine in molar proportions greater than 1. The stability of this process is dependent on the ability to control the degree of dehydration of the mixtures at all stages, and this is claimed to be managed through choosing residence times and the degree of dehydration of the feeds. The possibility of process upsets and difficulties in maintaining steady-state in such a system suggests limitations to general utility of the process. Controlling stoichiometric balance is left unresolved. In addition, only molten processing is disclosed: the problem of starting with solid acid-rich mixtures is not addressed. These limits suggest the need for a robust process that is inherently stable, in which molar balance can be reliably controlled and that encompasses solids handling.

The PCT patent document, WO 03/006529A1, discloses a process fundamentally similar to that of U.S. Pat. No. 5,731,403 but having three main distinctions. This PCT document disclosure emphasizes its discontinuous nature whereas the claims of U.S. Pat. No. 5,731,403 are more general. Stoichiometric control, which is not discussed in U.S. Pat. No. 5,731,403, is disclosed here using near-infrared in the manner of U.S. Pat. No. 5,674,974. Finally, the degree of dehydration during the intermediate balancing stage is not discussed but the temperature is instead selected to maintain the contents in the liquid state and avoid any solidification. The claims discuss selecting temperatures 20° C. above the temperature of fusion. The balancing step of this process is therefore conducted at higher temperatures than that of U.S. Pat. No. 5,731,403. This process therefore presents again the need for a process in which diamine vapor loss is minimized.

The preceding disclosures describe processes that encompass the polyamidation step. Much of the energy costs of conventional processes arise ahead of the final reactor, however, as the initial salt solution is concentrated prior to reactor charge. Other workers have therefore sought to utilize imbalanced mixtures to prepare concentrated salts and prepolymers in more efficient ways.

U.S. Pat. Nos. 4,213,884 and 4,251,653, herein incorporated by reference in their entirety, disclose a process that seeks to reduce the amount of solution water added to the system. It begins with an aqueous solution that contains 40-65% by weight of balanced salt into which an excess of alkanedicarboxylic acid is then dissolved. Molten diamine is added to this mixture under agitation and between 2-15 bar pressure until neutralization is achieved as determined by pH measurement. The temperature is allowed to increase during the neutralization to between 160-200° C. This process yields an aqueous solution containing salt and prepolymer at concentrations of between 70-90% by weight. Diamine losses in this process are managed both by feeding up to a 1 mol % excess of diamine and also by holding the system under pressure. This process does reduce the amount of water added, but significant amounts of water are still required for removal. This process utilizes molten diamine for neutralization instead of the aqueous diamine normally used to ease handling. This process also adds two layers of complexity to existing polyamidation operations. In addition to the normal salt strike which must continue to supply the starting salt, another diacid addition system and a separate additional neutralizing diamine system must be installed and controlled. There are therefore several disadvantages inherent in this approach. An economic process that avoids unnecessary costs and incorporates typical process considerations is needed.

U.S. Pat. No. 4,442,260, herein incorporated by reference in its entirety, teaches that diacid rich mixtures have higher water solubilities than balanced mixtures. At 55-60° C., balanced salt mixtures begin precipitating above about 59% concentration by weight, but diacid rich mixtures are reported to be stable up to 69%. A process is thereby disclosed in which diacid-rich aqueous salt solutions of between 60-69% concentration by weight of salt are prepared based on mixtures of 73.5-77.5% by weight of adipic acid and 22.5-26.5% hexamethylenediamine. These solutions are then concentrated by evaporating water to between 89-96% by weight. Hexamethylenediamine is then added until the mixture is in about stoichiometric balance. This process achieves higher starting salt concentrations but is still limited to water contents of between about 24.5 and 35.6% by weight. In addition, no method for controlling the stoichiometric balance of the final polymer is proposed. A process is therefore needed that further reduces the water in the system and improves control of the molar balance.

U.S. Patent Application No. 201010168375A1, herein incorporated by reference in its entirety, discloses a process that combines features of the preceding two examples. Whereas U.S. Pat. Nos. 4,213,884 and 4,251,653, herein incorporated by reference in their entirety, begin from a solution of balanced salt, this disclosure begins from a solution of acid rich mixtures similar to U.S. Pat. No. 4,442,260 but having a wider concentration range of 40 to 75% by weight. Whereas U.S. Pat. No. 4,442,260 then concentrates the solution by evaporation water ahead of balancing in the reactor, this disclosure concentrates by adding the balancing diamine to the solution. A condenser is used to return any vaporizing diamine. The concentration and pH are adjusted in a finishing step prior to loading the resulting salt solution into storage. The solutions of this process are claimed contain more than 50% by weight of salt. A process is therefore still needed that reduces the water in the system while still providing adequate control of molar balance.

U.S. Pat. No. 6,696,544B1, herein incorporated by reference in its entirety, discloses a substantially anhydrous and continuous process for preparing nylon prepolymers starting with a diacid-rich eutectic mixture of diacid and diamine. A diacid rich mixture and a diamine rich mixture are both prepared from the eutectic mixture via the addition of appropriate amounts of diamine. Condensate water is removed from both of the intermediate mixtures as amidation progresses. The diacid/diamine molar ratio of the diamine rich mixture is between 0.8 and 0.995. The diacid/diamine molar ratio of the diacid rich mixture is between 1.005 and 1.2. This disclosure contrasts itself from the more imbalanced molar ratios (>1.5) of streams described in the process of U.S. Pat. No. 4,131,712. It is reported therein that blending these two less imbalanced mixtures leads to improved control of the stoichiometric balance and less diamine loss. In the manner of U.S. Pat. No. 5,674,974, this process utilizes near-infrared to control the molar ratio of the various process steps. U.S. Pat. No. 6,995,233B2, herein incorporated by reference in its entirety, elaborates upon the start-up procedure of this process which involves beginning from a 62% by weight solution of balanced salt. This process is based on a cascade of stirred vessels with several NIR control points in an elaborate control methodology. As a result, the need for balanced salt at start-up is disadvantageous. A simpler process, and solution for this disadvantage, avoids the installation and complex control of so many vessels and does not require a start-up based on balanced salt.

### BRIEF DESCRIPTION OF THE DRAWINGS

FIG. 1 is a diagram showing a process for the preparation and drying of acid-rich mixtures for subsequent solidification.

FIG. 2 is a diagram showing a process for the preparation and drying of amine-rich mixtures for subsequent solidification.

FIG. 3 is a diagram showing a process for melting acid-rich solids and subsequent preparation of aqueous nylon salt solutions.

FIG. 4 is a diagram showing a continuous process for melting acid-rich solids and subsequent preparation of aqueous nylon salt solutions.

FIG. 5 is a diagram showing a continuous process for melting acid-rich solids and subsequent preparation of aqueous nylon salt solutions.

FIG. 6 is a diagram showing a process for melting amine-rich solids and subsequent preparation of aqueous nylon salt solutions.

FIG. 7 is a diagram showing a semi-continuous process for melting amine-rich solids and subsequent preparation of aqueous nylon salt solutions.

FIG. 8 is a diagram showing a semi-continuous process from the melt blending of acid-rich and amine-rich solids and subsequent preparation of aqueous salt solutions.

FIG. 9 is a diagram showing the continuous preparation of polyamides.

FIG. 10 is a diagram showing the continuous preparation of polyamide copolymers.

### SUMMARY OF THE INVENTION

The disclosures herein relate to a process for the production of polyamides that includes contacting one or more solidified stoichiometrically imbalanced components comprising mixtures of diacids and diamines.

Herein, the term stoichiometrically imbalanced refers to a component having a molar ratio defined as moles dicarboxylic acid units divided by moles of diamine units; the molar ratio being different from unity.

In a first aspect, the process for production of a polyamide composition from one or more solidified stoichiometrically imbalanced mixtures of diacids and diamines; includes the following process steps:
a) forming an acid-rich solidified first component in a dry or moisture containing state by;
b) contacting at least a dicarboxylic acid with at least a diamine in a molar ratio of greater than 1:1;
c) forming an amine-rich solidified second component in a dry or moisture containing state by;
d) contacting at least a dicarboxylic acid with at least a diamine in a molar ratio of less than 1:1;
e) contacting the acid-rich first component with the amine-rich second component in a molten state or a solution state and
f) forming a first composition having a composition molar ratio
g) such that a total dicarboxylic acid content and a total diamine content, supplied by said first and second components, is from about 0.95 to about 1.05;
h) heating the first composition with agitation in the molten state and under pressure to a sufficiently high temperature for a polyamidation reaction to and subsequently,
i) forming a second composition comprising a polyamide.

In another aspect, the process for production of a polyamide composition from one or more solidified stoichiometrically imbalanced mixtures of diacids and diamines; includes wherein the molar ratio of the diacid to the diamine, whether free or chemically combined, in the acid-rich component is at least 1.5:1.

In another aspect, the process for production of a polyamide composition from one or more solidified stoichiometrically imbalanced mixtures of diacids and diamines; includes wherein the dicarboxylic acid is adipic acid and the diamine is hexamethylenediamine.

In yet a further aspect, the process for production of a polyamide composition from one or more solidified stoichiometrically imbalanced mixtures of diacids and diamines; includes wherein the dicarboxylic acid includes one or more diacids selected from the group consisting of:
oxalic acid, malonic acid, succinic acid, glutaric acid, pimelic acid, adipic acid, suberic acid, azelaic acid, sebacic acid, undecanedioic acid, dodecandioic acid, maleic acid, glutaconic acid, traumatic acid, and muconic acid, 1,2- or 1,3-cyclohexande dicarboxylic acids, 1,2- or 1,3-phenylenediacetic acids, 1,2- or 1,3-cyclohexane diacetic acids, isophthalic acid, terephthalic acid, 4,4′-oxybisbenzoic acid, 4,4-benzophenone dicarboxylic acid, 2,6-napthalene dicarboxylic acid, p-t-butyl isophthalic acid and 2,5-furandicarboxylic acid.

In yet a further aspect, the process for production of a polyamide composition from one or more solidified stoichiometrically imbalanced mixtures of diacids and diamines; includes wherein the diamine selected from the group consisting of:
ethanoldiamine, trimethylenediamine, putrescine, cadaverine, hexamethyelenediamine, 2-methyl pentamethylenediamine, heptamethylenediamine, 2-methyl hexamethylenediamine, 3-methyl hexamethylenediamine, 2,2-dimethyl pentamethylenediamine, octamethylenediamine, 2,5-dimethyl hexamethylenediamine, nonamethylenediamine, 2,2,4- and 2,4,4-trimethyl hexamethylenediamines, decamethylenediamine, 5-methylnonanediamine, isophoronediamine, undecamethylenediamine, dodecamethylenediamine, 2,2,7,7-tetramethyl octamethylenediamine, meta-xylylene diamine, paraxylylene diamine, bis(p-aminocyclohexyl)methane, bix(aminomethyl)norbornane, any C₂-C₁₆ aliphatic diamine optionally substituted with one or more C₁ to C₄ alkyl groups, aliphatic polyether diamines and furanic diamines such as 2,5-bis(aminomethyl)furan.

In yet a further aspect, the process for production of a polyamide composition from one or more solidified stoichiometrically imbalanced mixtures of diacids and diamines; includes wherein the solidified acid-rich component melts below 155° C. at atmospheric pressure.

In yet a further aspect, the process for production of a polyamide composition from one or more solidified stoichiometrically imbalanced mixtures of diacids and diamines; includes wherein a granular form of the solidified acid-rich component does not fuse during storage or optionally during shipment.

In yet a further aspect, the process for production of a polyamide composition from one or more solidified stoichiometrically imbalanced mixtures of diacids and diamines; includes wherein the granular form of the solidified acid-rich component flows freely.

In yet a further aspect, the process for production of a polyamide composition from one or more solidified stoichiometrically imbalanced mixtures of diacids and diamines; includes wherein a bulk form of the solidified acid-rich component melts without degradation or discoloration.

In yet a further aspect, the process for production of a polyamide composition from one or more solidified stoichiometrically imbalanced mixtures of diacids and diamines; includes wherein a solidified amine-rich component melts without degradation or discoloration whether it is solidified into bulk or granular form.

In yet a further aspect, the process for production of a polyamide composition from one or more solidified stoichiometrically imbalanced mixtures of diacids and diamines; includes wherein a granular form of the solidified amine-rich component flows freely.

In yet a further aspect, the process for production of a polyamide composition from one or more solidified stoichiometrically imbalanced mixtures of diacids and diamines; includes wherein the granular form of the solidified amine-rich component does not fuse during storage or optionally during shipment.

In yet a further aspect, the process for production of a polyamide composition from one or more solidified stoichiometrically imbalanced mixtures of diacids and diamines; includes wherein the amine-rich component is hexamethylenediamine in molten form or aqueous solution.

In yet a further aspect, the process for production of a polyamide composition from one or more solidified stoichiometrically imbalanced mixtures of diacids and diamines; includes wherein additional water is added to dilute the blend of the molten imbalanced mixtures.

In yet a further aspect, the process for production of a polyamide composition from one or more solidified stoichiometrically imbalanced mixtures of diacids and diamines; includes wherein the amine-rich second component is contacted in a state of aqueous dilution.

### DETAILED DESCRIPTION OF THE INVENTION

The process embodiments herein exploit the melt properties of stoichiometrically imbalanced diacid-diamine blends to manufacture polyamides more efficiently. Herein, and hereinafter, the term stoichiometrically imbalanced refers to a component having a molar ratio defined as moles dicarboxylic acid units divided by moles of diamine units; the molar ratio being different from unity. Imbalanced blends of components are intentionally solidified for shipment and storage. The solids are later melted out for balancing into salts and prepolymers followed by either storage or subsequent polymerization in conventional batch, semi-batch, or continuous reactors. The solids may alternatively be used directly in a single operation that melts, balances and drives polymerization.

It is well known that dicarboxylic acid powders such as adipic acid are prone to caking, and this makes its bulk transport challenging and often laborious. This leads diacid producers to expend undesirable amounts of time and energy drying the product thoroughly prior to loading. It is known, such as via the process of U.S. Pat. No. 3,459,798; the disclosures of which are included by reference in their entirety, to add anti-caking agents. The use of such additives, however, may sometimes contribute to problems in downstream use of the resulting polymer so a cumbersome level of testing and approval is required prior to practicing that approach. This invention provides a solution to the caking problem without such complications.

Many diamines solidify at ambient conditions. Hexamethylenediamine, for example, solidifies at about 42° C. Water is commonly added to depress this melt temperature and ease handling. It is therefore common to see bulk shipments containing upwards of 5 weight percent water which has only been added to facilitate unloading. This practice raises transportation costs and adds to the water that must be removed during polyamidation. Steaming rail cars to melt also increases the likelihood of degrading the diamine. This invention eliminates these problems.

A diacid-rich mixture is produced at the location of the diacid production or at a location where it off-loaded from bulk containers. By diacid-rich it is meant that the diacid/diamine molar ratio is greater than unity (1:1). Such mixtures can exhibit melt temperatures that are usefully lower than that of the balanced salt or of the starting diacid or sometimes of both. This allows for the melting of the diacid-rich mixture without discoloration or degradation of the diacid component.

A diamine-rich mixture is also produced at the location either of the diamine production or of the diacid production or where it is available from bulk containment. By diamine-rich it is meant that the diacid/diamine molar ratio is less unity (1:1). Such mixtures can similarly exhibit melt temperatures that are lower than that of the balanced salt and low enough to avoid degradation.

If no condensation water is removed, the imbalanced mixtures are said to be at zero dehydration. If all moisture and condensation water is removed, the mixtures are said to be in a state of full dehydration. It is found that the degree of dehydration does not reduce the utility of this invention. Low degrees of dehydration exhibit greater melt point depression so may be advantageous. It may instead be more useful for other reasons to fully dehydrate the mixture prior to shipment or to select an intermediate degree of dehydration. The degree of dehydration chosen might vary depending on the means of transport required or in view of other factors, but any degree of dehydration may be utilized without departing from this invention. The selection criteria is determined by the mode of transport that best suits the use of the imbalanced mixture.

Neither the diacid nor the diamine needs to be in a dry state for the preparation of the imbalanced mixtures. Lower amounts of moisture in the resulting mixtures are more efficiently transported and stored; however, any of the various dehydration processes available can be applied after the imbalanced mixture has been prepared. These may be applied by processing the molten mixture or by treating the mixture after solidification. Such processes may include batch wise methods such as via tank evacuation or continuous modes such as distillation, flash tanks, cascades of tanks in various temperature and pressures, wiped film evaporators, or tray dryers.

The imbalanced mixtures may be prepared using one or more dicarboxylic acids. Suitable diacids include oxalic acid, malonic acid, succinic acid, glutaric acid, pimelic acid, adipic acid, suberic acid, azelaic acid, sebacic acid, undecanedioic acid, dodecandioic acid, maleic acid, glutaconic acid, traumatic acid, muconic acid, 1,2- or 1,3-cyclohexande dicarboxylic acid, 1,2- or 1,3-phenylenediacetic acid, 1,2- or 1,3-cyclohexane diacetic acid, isophthalic acid, terephthalic acid, 4,4-oxybis (benzoic acid), 4,4-benzophenone dicarboxylic acid, 2,6-napthalene dicarboxylic acid and p-t-butyl isophthalic acid. Furanic diacids such as 2,5-furandicarboxylic acid are also suitable.

The imbalanced mixtures may also be prepared by using one or more diamines. Suitable diamines include ethanoldiamine, trimethylenediamine, putrescine, cadaverine, hexamethyelenediamine, 2-methyl pentamethylenediamine, heptamethylenediamine, 2-methyl hexamethylenediamine, 3-methyl hexamethylenediamine, 2,2-dimethyl pentamethylenediamine, octamethylenediamine, 2,5-dimethyl hexamethylenediamine, nonamethylenediamine, 2,2,4- and 2,4,4-trimethyl hexamethylenediamines, decamethylenediamine, 5-methylnonanediamine, isophoronediamine, undecamethylenediamine, dodecamethylenediamine, 2,2,7,7-tetramethyl octamethylenediamine, meta-xylylene diamine, paraxylylene diamine, bis(p-aminocyclohexyl)methane, bix(aminomethyl)norbornane, and any C₂-C₁₆ aliphatic diamine optionally substituted with one or more C₁ to C₄ alkyl groups. Aliphatic polyether diamines are also suitable. Furanic diamines such as 2,5-bis(aminomethyl)furan are also suitable.

In addition to polyamides based solely on diacid and diamines, it is sometimes advantageous to incorporate other reactants. When added at proportions less than 20% by weight, these may be added into the molten imbalanced mixtures prior to solidification without departing from this invention. Such reactants may include monofunctional carboxylic acids such as formic acid, acetic acid, propionic acid, butyric acid, valeric acid, benzoic acid, caproic acid, enanthic acid, octanoic acid, pelargonic acid, capric acid, undecanoic acid, lauric acid, myristic acid, myristoleic acid, palmitic acid, palmitoleic acid, sapienic acid, stearic acid, oleic acid, elaidic acid, vaccenic acid, linoleic acid, erucic acid and the like. These may also include lactams such as α-acetolactam, α-propiolactam, β-propiolactam, γ-butyrolactam, δ-valerolactam, γ-valerolactam, caprolactam and the like. These may also include lactones such as α-acetolactone, α-propiolactone, β-propiolactone, γ-butyrolactone, δ-valerolactone, γ-valerolactone, caprolactone, and such like. These may include difunctional alcohols such as monoethylene glycol, diethylene glycol, 1,2-propanediol, 1,3-propanediol, dipropylene glycol, 1,2-butanediol, 1,3-butanediol, 1,4-butanediol, 2,3-butanediol, 1,2-pentanediol, 1,5-pentanediol, etohexadiol, p-menthane-3,8-diol, 2-methyle-2,4-pentanediol, 1,6-hexanediol, 1,7-heptanediol, and 1,8-octanediol. Higher functionality molecules such as glycerin, trimethylolpropane, triethanolamine and the like may also be useful. Suitable hydroxylamines may also be selected such as ethanolamine, diethanolamine, 3-amino-1-propanol, 1-amino-2-propanol, 4-Amino-1-butanol, 3-amino-1-butanol, 2-Amino-1-butanol, 4-amino-2-butanol, pentanolamine, hexanaolamine, and the like. It will be understood that blends of any of these reactants may also be utilized without departing from this invention.

It is also sometimes advantageous to incorporate other additives into the molten imbalanced mixtures prior to solidification. These additives may include heat stabilizers such as copper salts, potassium iodide, or any of the other antioxidants known in the art. Such additives may also include polymerization catalysts such as metal oxides, acidic compounds, metal salts of oxygenated phosphorous compounds or others known in the art. Such additives may also be delustrants and colorants such as titanium dioxide, carbon black, or other pigments, dyes and colorants known in the art. Additives used may also include antifoam agents such as silica dispersions, silicone copolymers, or other antifoams known in the art. Lubricant aids such as zinc stearate, stearylerucamide, stearyl alcohol, aluminum distearate, ethylenebisstearamide or other polymer lubricants known in the art may be used. Nucleating agents may be included in the mixtures such as fumed silica or alumina, molybdenum disulfide, talc, graphite, calcium fluoride, salts of phenylphosphinate or other aids known in the art. Other common additives known in the art such as flame retardants, plasticizers, impact modifiers, and some types of fillers may also be added into the molten imbalanced mixtures prior to solidification. It will be understood that blends of any of these reactants may also be utilized without departing from the fundamentals of the embodiments disclosed herein.

The molten imbalanced mixtures are solidified into a form most suited to the mode of their next use. That form determines the properties required of the solid. These properties are controlled by varying the diacid/diamine molar ratio and the degree of dehydration. These directly determine the melt temperature and the tackiness of the surface.

In some cases, it may be beneficial to melt out and then pump the imbalanced mixture into the next process, and in such applications the molten imbalanced mixture may be loaded into transportable vessels and be allowed to solidify. Such vessels may be large such as steam-able rail cars or relatively small such as drums or cans. In that context, tackiness is less important relative to a low melting point that facilitates melt out and use without discoloration.

In other cases, it may be beneficial to charge the next process with granules, formed either as flakes or pellets. Off-load and handling of such granules often improves if they are free flowing. In that context melt temperature can become less important relative to producing granules that flow easily and do not fuse. Flake or pellet size, shape and smoothness are important to achieving acceptable flow.

This process advantageously uses the melt properties of imbalanced mixtures for the production of polyamide salts, prepolymers and polymers by solidifying the imbalanced intermediates into convenient solid forms. The invention provides several advantages which may include:

1) The contemplated embodiments provide simpler designs than previous disclosures by reducing the number of unit operations in the process. This reduces plant footprint and capital costs.
2) Smaller working volumes lead directly to less inventory in intermediate stages of processing, reducing costs related to process upsets and shutdowns.
3) The process may be directly fed from substantially anhydrous feed materials containing less than about 50 weight percent moisture, thereby reducing energy costs.
4) Lower thermal history which serves to reduce discoloration and degradation.
5) In-line monitoring via mid-infrared, near-infrared or Raman spectroscopy can provide single-point control of stoichiometry.
6) Multiple feed-ports in the process designs may be exploited to efficiently produce copolymers of multiple diacids or diamines.
7) Salt and prepolymers can be prepared in a manner that can feed existing polymerization units without disrupting existing operations or requiring substantial reengineering.

These advantages will be better understood in the context of some non-limiting illustrative examples. For the purposes of discussion, it will be understood that the term salt is used in a general sense to encompass the precursors to polyamidation whether in a fully ionized state, an oligomeric state, or in any combination thereof.

### EXAMPLES

### Example 1

### Preparation of Pelletized Acid-Rich Solids

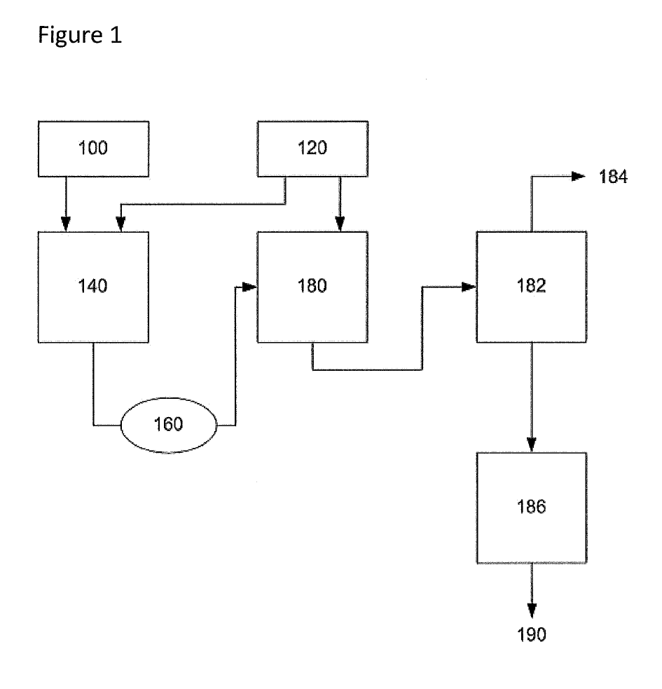

The description of this example may be better understood by reference to FIG. 1. Under an inert atmosphere and without the presence of oxygen, wet adipic acid (100 in FIG. 1) is fed at 100 kg/min into a continuous stirred tank reactor (140) used as the primary mix vessel. This adipic acid feed (100) contains 10% water by weight but the moisture content can be varied. It is understood that the real limit of incoming moisture content is economically sizing the mix vessels and distillation column. Anhydrous adipic acid also functions well. The primary mix vessel (140) is well stirred and the anhydrous hexamethylenediamine (120) is fed into the vessel (140) under agitation at a rate of 22.5 kg/min. Aqueous solutions of hexamethylenediamine can also be used. It is understood that the molar ratio of diacid to diamine can be varied above 1 without departing from this invention so long as other process conditions are selected to achieve an adequate melt.

The 1.5 cubic meter primary (140) and secondary (180) mix vessels are jacketed 316 stainless steel vessels and sized to provide 10 min residence times. Both vessels are well agitated and equipped with internal coils for heating and cooling. NIR (160) spectrophotometric control (e.g. using a UOP/Guided Wave Model 300P near-infrared spectrometer or similar means known in the art) is applied in the manner of U.S. Pat. No. 5,674,974; incorporated by reference in its entirety herein. Although it could additionally be used after the secondary mix vessel and the distillation column (182), it is found that monitoring at a single point after the primary mix vessel (140) is adequate at steady-state. Although the system was designed to add a smaller hexamethylenediamine feed (120) into the secondary mix vessel (180) as a trimming correction based on the NIR data, it is found that this is rarely required.

The primary and secondary mix vessels are operated at 125° C. and atmospheric pressure under nitrogen blanketing to maintain an inert atmosphere. The melt from the secondary mix vessel is charged to the sixth tray of a ten tray, titanium distillation column (182) which is operated at atmospheric pressure. This configuration provides four upper trays for scrubbing adipic acid and hexamethylenediamine from the rising vapor. This configuration also provides six lower trays to drive water out of the falling melt. By optimizing the temperature gradient in the column, with the top tray at about 95° C. and the bottom tray at about 180° C., this configuration is found to be adequate to maintain less than 0.5% moisture by weight in the melt and less than 100 parts per million by weight of hexamethylenediamine in the escaping vapor. In an alternative embodiment using different feed rates and process conditions to achieve diacid/diamine molar ratios less than 3, an equalizer coil between the secondary mix vessel (180) and the distillation column (182) is found to be useful. In another embodiment not shown, it is also found that an extruder configured to achieve the required amount of mixing may be used in place of either or both of the mix vessels.

The largely dehydrated melt from the distillation column is then distributed onto a stainless steel belt (186) equipped with cooling, as commonly employed in the art. The distribution is such that droplets of between about 1.0-2.0 mm in diameter are formed. It is found that other particle sizes may be selected so long as the flow or storage-stability of the solids is not impeded. The cooling of the belt is adjusted such that the pellets have solidified by the end of the conveyor belt and are collected into a hopper (190) for transport and storage. Depending on the moisture content of the incoming feeds and also the demands of the subsequent storage and use of the solids, the dehydration step in the distillation column may optionally be excluded or by-passed. In an alternative embodiment, the acid-rich melt is directly loaded to drums without pelletization and sealed for storage and transport to be later melted out prior to use. It will be understood that the size and configuration of such other vessels can be varied without departing from the scope of this invention. In another alternative embodiment, the acid-rich melt is not dried but rather is loaded directly to drums or other suitable containers for sealing and transport. In another embodiment not shown, it is also found that an extruder configured to achieve the required amount of mixing may be used in place of either or both of the mix vessels.

### Example 2

### Preparation of Pelletized Amine-Rich Solids

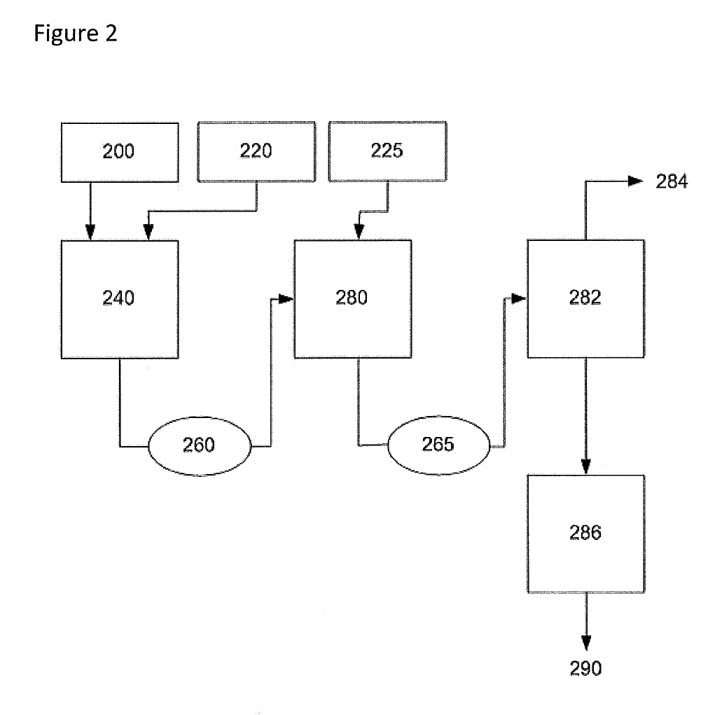

The description of this example may be better understood by reference to FIG. 2. In the manner of Example 1, wet adipic acid (200) is fed at 26.8 kg/min into the primary mix vessel (240). Anhydrous hexamethylenediamine (220) is added under agitation at a rate of 6.1 kg/min. This process is controlled via feedback from the online NIR instrument (260). The vessel (240) is maintained at 125° C. and atmospheric pressure under nitrogen blanketing to maintaining an inert atmosphere. It is understood that the molar ratio of diacid to diamine can be varied below 1 without departing from this invention so long as other process conditions are selected to achieve an adequate melt. Other moisture contents of the diacid and diamine feeds can be selected without departing from this invention.

The molten acid-rich mixture is fed into the secondary mix vessel (280) to which anhydrous hexamethylenediamine (225) is added under agitation at a rate of 89.6 kg/min. This process is controlled via feedback from the online NIR instrument (265). In an alternative embodiment, the online NIR instrument is located instead on the molten product of the distillation column. This vessel is maintained at 175° C. under nitrogen at about 116 psig.

As in Example 1, the molten product of the secondary mix vessel (280) is fed via a pressure-reducing flasher to the sixth tray of a ten tray, titanium distillation column (282) which is operated at atmospheric pressure. This configuration provides four upper trays for scrubbing adipic acid and hexamethylenediamine from the rising vapor. This configuration also provides six lower trays to drive water out of the falling melt. By optimizing the temperature gradient in the column, with the top tray at about 95° C. and the bottom tray at about 185° C., this configuration is found to be adequate to maintain less than 0.5% moisture by weight in the melt and less than 100 parts per million by weight of hexamethylenediamine in the escaping vapor. In an alternative embodiment using different feed rates and higher temperatures to achieve diamine/diacid molar ratios less than 3, use of an equalizer coil between the secondary mix vessel and the distillation column is found to be useful.

In the manner of Example 1, the largely dehydrated melt from the distillation column (282) is pelletized, at 286 in FIG. 2, such that granules of about 1.0-2.0 mm in diameter are formed. Other particle sizes can be used. These granules (290) are collected in containers appropriate for storage and transport. Depending on the moisture content of the incoming feeds and also the demands of the subsequent storage and use of the solids, the dehydration step in the distillation column may optionally be excluded or by-passed. In an alternative embodiment, the amine-rich melt is loaded directly to drums without pelletization and sealed for storage and transport to be later melted out prior to use. It will be understood that the size and configuration of such other vessels can be varied without departing from the scope of this invention. In another alternative embodiment, the amine-rich melt is not dried but rather is loaded directly to drums or other suitable containers for sealing and transport. In another embodiment not shown, it is also found that an extruder configured to achieve the required amount of mixing may be used in place of either or both of the mix vessels.

### Example 3

### Preparation of Salt Solutions from Pelletized Acid-Rich Solids

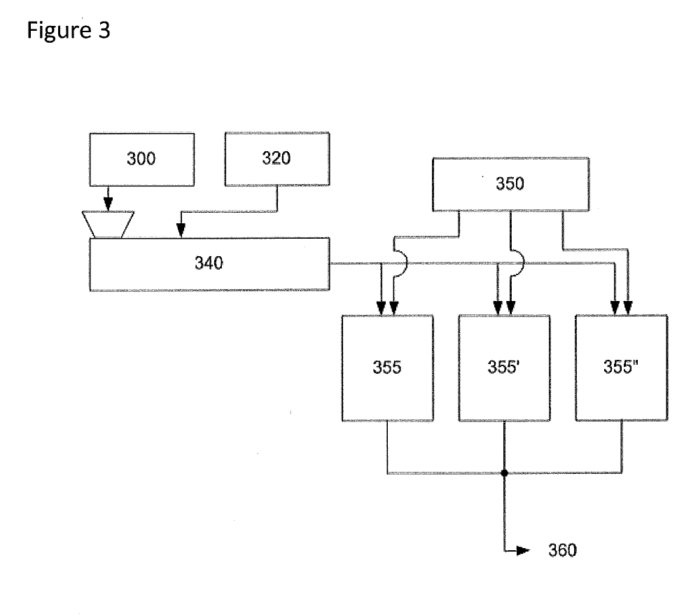

The description of this example may be better understood by reference to FIG. 3. The apparatus includes a single screw extruder (340) constructed of corrosion-resistant alloys utilizing a screw that is designed to promote mixing such that additives can be injected along the barrel as desired. It also includes three mix vessels (355, 355′, 355″) that are similar to those of Example 1. Twin screw extruders are also suitable for this use. The vessels (355, 355′, 355″) are sequenced through three stages to maintain uninterrupted input and output. The vessels (355, 355′, 355″) are maintained under agitation at 140° C. and about 43 psig or higher under inert atmosphere.

The acid-rich pellets (300) of Example 1 are conveyed by known means at a rate of 20.0 kg/min to a single screw extruder (340) under inert atmosphere. The extruder is operated to melt the pellets smoothly at 125° C. Water (320) is injected in this example at a rate of 9.1 kg/min such that an aqueous solution at about 68.4% by weight of the acid-rich mixture is supplied sequentially to the mix vessels (355, 355′, 355″). It is understood that, without departing from this invention, the water feed (320) in this configuration can be varied to supply more dilute salt solutions for greater storage stability or more concentrated solutions for more direct polyamidation.

During the filling stage, the aqueous acid-rich solution from the extruder is charged to a vessel (355, 355′, 355″). Hexamethylenediamine (350) is simultaneously added at a rate of between 10.25-10.3 kg/min as an aqueous solution which contains 90% by weight hexamethylenediamine. The filling stage ends when the level reaches 1,250 kg. This is measured by load cells on the mix vessel, but it could alternatively be measured by metering on the feeds or by calibration of liquid level.

Stage 2 is for pH adjustment. Samples are collected and pH is determined by known means. Online evaluation via near-infrared and Raman spectroscopic techniques are also useful. Additional aqueous hexamethylenediamine is added until balance is achieved within the desired range. An overall molar balance of the diacid and diamine of between 0.995 and 1.005 is achieved. Once balance is achieved, Stage 2 is complete and the tank is held at temperature and pressure under agitation and inert atmosphere. This process yields an aqueous solution (360) containing 74% by weight of a mixture of ionized adipic acid, ionized hexamethylenediamine and various oligomers of the two monomers.

In Stage 3, the vessel is emptied at about 39.4 kg/min for use in the next process or for storage. The next process in this example is concentration via evaporation followed by polyamidation to desirably high molecular weight in sequentially used batch autoclaves. Alternatively, this configuration can be used to supply continuous polyamidation reactors. It will be understood that the number and combination of mix vessels can be varied, including a single vessel used for discontinuous production, without departing from this invention. In an embodiment not shown, the acid-rich solid feed is replaced with a liquid feed of acid-rich mixture melted from bulk solidification.

### Example 4

### Preparation of Salt Solutions from Pelletized Acid-Rich Solids

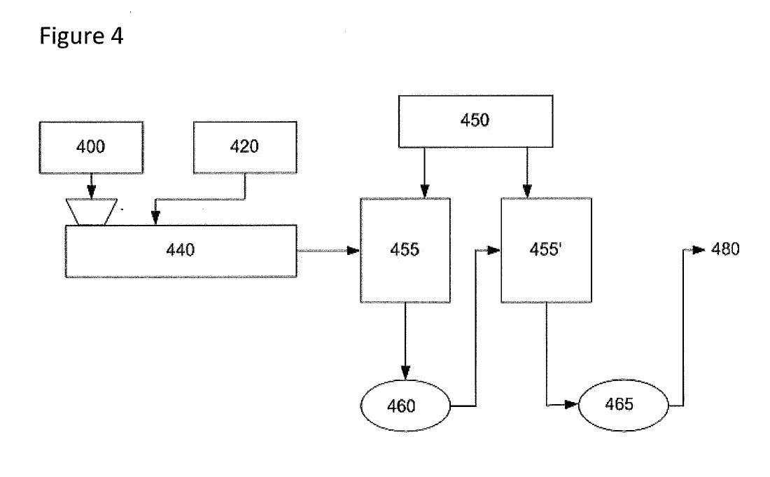

The description of this example may be better understood by reference to FIG. 4. The acid-rich pellets (400) of Example 1 are conveyed by known means at 20.0 kg/min to a single screw extruder (440) under inert atmosphere. The extruder (440) is operated to melt the pellets smoothly at 125° C. The extruder is constructed of corrosion-resistant alloys and the screw is designed to promote mixing such that additives can be injected along the barrel as desired. Twin screw extruders are also suitable for this use. Water (420) is injected in this example at a rate of 9.1 kg/min such that an aqueous solution at about 68.4% by weight of the acid-rich mixture is supplied to the primary mix vessel (455). It is understood that, without departing from this invention, the water feed in this configuration can be varied to supply more dilute salt solutions for greater storage stability or more concentrated solutions for more direct polyamidation.

The mix vessels (455, 455′) are similar to those of Example 1. The vessels (455, 455′) are maintained under agitation at 140° C. and at least 20 psig under inert atmosphere. Hexamethylenediamine (450) is added at a rate of between 10.25-10.3 kg/min as an aqueous solution which contains 90% by weight hexamethylenediamine. Other concentrations including anhydrous hexamethylenediamine may be used. Samples are taken from the effluent of each mix vessel (455, 455′) for evaluation of pH by known means (460, 465) to assess and adjust stoichiometric balance; however, feedback from online Raman spectroscopy is found to also be useful. Once steady-state is achieved it is found that it is only necessary to add the aqueous hexamethylenediamine to the primary mix vessel and the trim feed to the secondary vessel is stopped. This process yields an aqueous solution (480) that contains 74% by weight of a mixture of ionized adipic acid, ionized hexamethylenediamine and various oligomers of these. An overall molar balance of the diacid and diamine of between 0.995 and 1.005 is achieved at steady state. The resulting solution is supplied at about 39.4 kg/min for use in the next process or for storage. The next process in this example is concentration via evaporation followed by polyamidation to desirably high molecular weight in sequentially used batch autoclaves. Alternatively, this configuration can be used to supply continuous polyamidation reactors. In an embodiment not shown, the acid-rich solid feed is replaced with a liquid feed of a molten acid-rich mixture. In another embodiment not shown it is found that a single mix vessel provides adequate back-mixing at steady-state to produce an aqueous salt solution within stoichiometric balance.

### Example 5

### Preparation of Salt Solutions from Pelletized Acid-Rich Solids

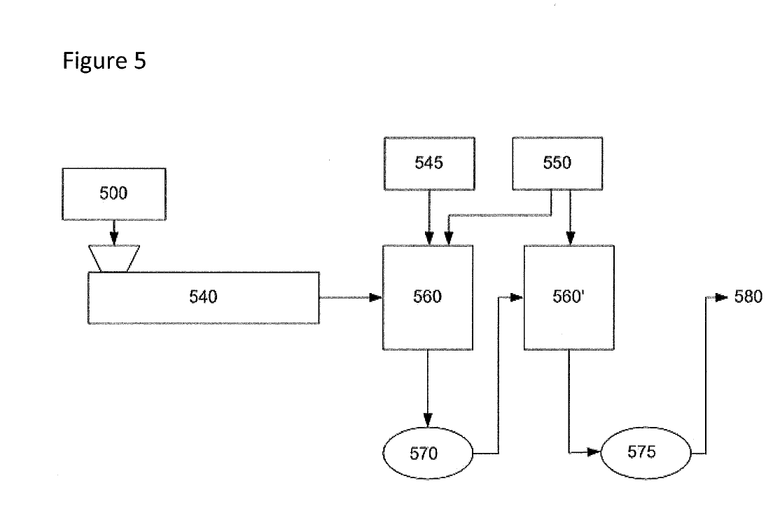

The description of this example may be better understood by reference to FIG. 5. The acid-rich pellets (500) of Example 1 are conveyed by known means to a single screw extruder (540) under inert atmosphere. The extruder (540) is operated to melt the pellets smoothly such that a clear melt at 125° C. is supplied to the primary mix vessel at a rate of 20.0 kg/min. The extruder is constructed of corrosion-resistant alloys and the screw is designed to promote mixing such that additives can be injected along the barrel as desired.

The mix vessels (560, 560′) are similar to those of Example 1. The vessels (560, 560′) are maintained under agitation at 165° C. and at least 45 psig under inert atmosphere. Hexamethylenediamine (550) is added at a rate of between 10.25-10.3 kg/min as an aqueous solution which contains 90% by weight hexamethylenediamine. Water (545) is added at a rate of 4.0 kg/min. It is understood that, without departing from this invention, the water feed in this configuration can be varied to supply more dilute salt solutions for greater storage stability or more concentrated solutions for more direct polyamidation.

Samples are taken from the effluent of each mix vessel for evaluation of pH by known means ((570, 575) for assessing and adjusting stoichiometric balance; however online NIR or Raman techniques are both found to be useful feedback techniques. Once steady state is achieved it is found that it is only necessary to add the aqueous hexamethylenediamine (550) to the primary mix vessel (560) and the trim feed to the secondary vessel (560′) is stopped. This process yields an aqueous solution (580) that contains 85% by weight of a mixture of ionized adipic acid, ionized hexamethylenediamine and various oligomers of these. An overall molar balance of the diacid and diamine of between 0.995 and 1.005 is achieved at steady state. The resulting solution is charged under pressure and at temperature to a batch autoclave or continuous reactor and then polymerized to high molecular weight. Alternatively, the solution may be stored. In an embodiment not shown, the water may be added to the secondary mix vessel. In an alternative embodiment not shown, an appropriately sized transfer line is utilized to increase residence time between the secondary mix vessel and the polyamidation system. In another embodiment not shown, it is found that one or both of the mix vessels can be replaced with inline mixers and transfer lines of suitable length. In another embodiment, anhydrous hexamethylenediamine may be used. The acid rich solid feed may be replaced with a liquid acid-rich feed melted from bulk solidification. It will be understood that all such variations may be contemplated without departing from this invention.

### Example 6

### Preparation of Salt Solutions from Pelletized Amine-Rich Solids

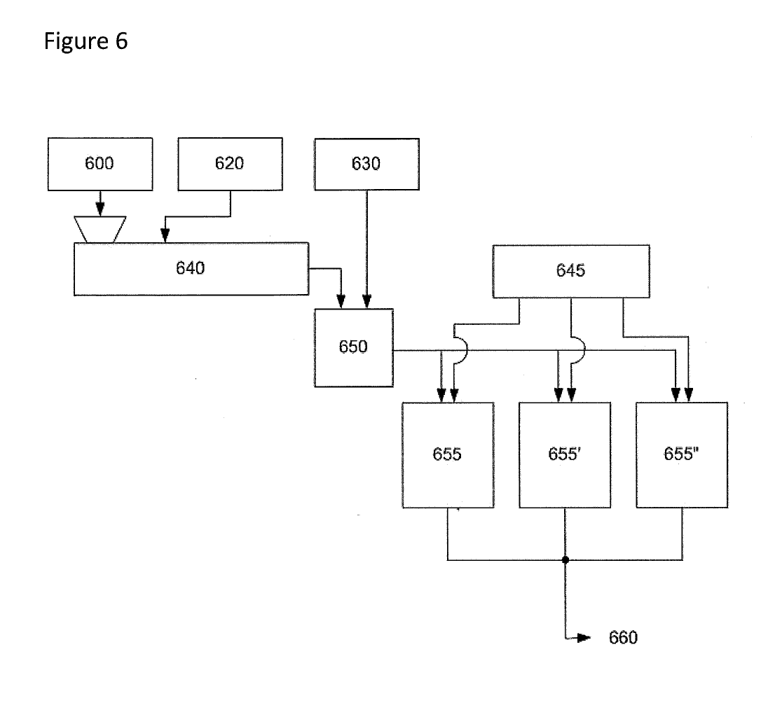

The description of this example may be better understood by reference to FIG. 6. The apparatus is similar to that of Example 3 with two exceptions. A screw conveyor (630) controlled via loss-in-weight feedback is included for the metering of substantially dry adipic acid powder through a pressurized lock hopper to the mix vessel (650). The second variation in this example is that of an additional mix vessel (650) of similar type to those of Example 1 that is added to blend the aqueous amine-rich solution with the adipic acid. In the manner of Example 3, the other three mix vessels (655, 655′, 655″) are sequenced through three stages to maintain uninterrupted input and output. The first mix vessel (650) is maintained at above 140° C. and at least 4 psig under inert atmosphere. The other mix vessels (655, 655′, 655″) are maintained under agitation above 115° C. and at least 4 psig under inert atmosphere.

The amine-rich pellets of Example 2 are conveyed by known means at a rate of 20.0 kg/min to a single screw extruder (640) under inert atmosphere. The extruder (640) is operated to melt the pellets smoothly at 170° C. Water (620) is injected in this example at a rate of 19.7 kg/min such that an aqueous solution at about 49.9% by weight of the amine-rich mixture is supplied to the first mix vessel. It is understood that, without departing from this invention, the water feed (620) in this configuration can be varied to supply more dilute salt solutions for greater storage stability or more concentrated solutions for more direct polyamidation. Substantially dry and oxygen-free adipic powder (630) is supplied to the first mix vessel (650) at a rate of 16.9 kg/min. This slightly acid-rich blend is then sequentially loaded to the next mix vessels (655, 655′, 655″) for balancing at a rate of about 56.6 kg/min.

During the filling stage, the aqueous acid-rich solution from the first mix vessel (650) is charged to one of the other three mix vessels (655, 655′, 655″). The filling stage ends when the level reaches 1,250 kg. This is measured by load cells on the mix vessel, but it could alternatively be measured by metering on the transfer line or by calibration of liquid level.

Stage 2 is for pH adjustment. Samples are collected and pH is determined by known means but online near-infrared or Raman spectroscopy are also useful. Aqueous hexamethylenediamine is added until balance is achieved within the desired range, but anhydrous hexamethylenediamine is also be used. It is understood that amine-rich solids from Example 2 could also be used for this purpose either via solid addition, in molten form, or as an aqueous solution. An overall molar balance of the diacid and diamine of between 0.995 and 1.005 is achieved. Once balance is achieved, Stage 2 is complete and the tank is held at temperature and pressure under agitation and inert atmosphere. This process yields an aqueous solution (660) that contains about 65.1% by weight of a mixture of ionized adipic acid, ionized hexamethylenediamine and various oligomers of the two monomers.

In Stage 3, the vessel is emptied at about 56.7 kg/min for use in the next process or for storage. The next process in this example is concentration via evaporation followed by polyamidation to desirably high molecular weight in a series of sequentially used batch autoclaves. Alternatively, this configuration can be used to supply continuous polyamidation reactors with suitable concentration stages. It will be understood that the number and combination of mix vessels in this example can be varied, including a single vessel used for discontinuous production, without departing from this invention. In an embodiment not shown, the amine-rich solid feed is replaced with a liquid feed of amine-rich mixture melted from bulk solidification.

### Example 7

### Semi-Continuous Preparation of Salt Solutions from Amine-Rich Solids

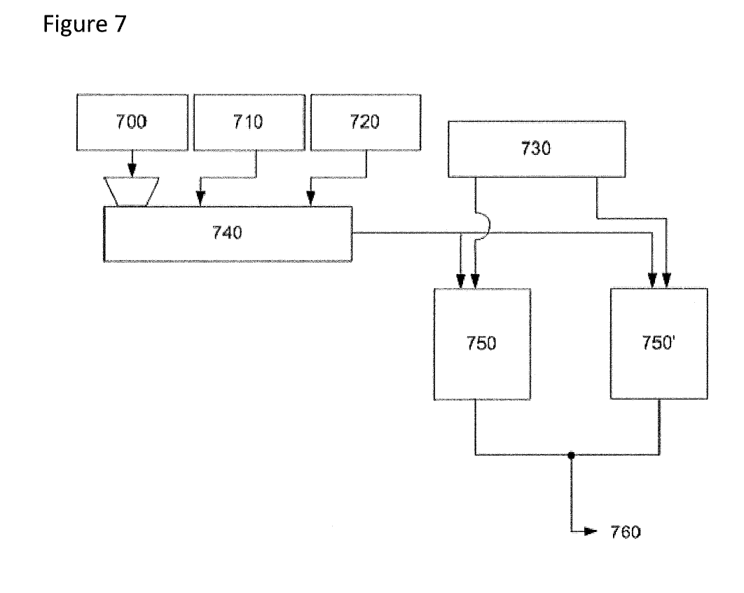

The description of this example may be better understood by reference to FIG. 7. The amine-rich pellets (700) of Example 2 are conveyed by known means at a rate of 20.0 kg/min to a single screw extruder (740) under inert atmosphere. The extruder (740) is operated to melt the pellets (700) smoothly to a clear melt at 170° C. The extruder (740) is constructed of a corrosion-resistant alloy and the screw is designed to promote mixing such that additives can be injected along the barrel as desired. In an alternative embodiment it is found that a twin screw extruder can also be configured to satisfy the requirements of this example.

In this example a metering screw conveyor (720) is used to charge adipic acid to a side feeder along the extruder barrel. The adipic acid is charged at 16.9 kg/min. A liquid port is used to charge water (710) at 4 kg/min. By appropriate design of the screw, adequate mixing is achieved to produce a clear aqueous salt solution. It will be understood that, without departing from this invention, the water feed (710) in this configuration can be varied to supply more dilute salt solutions for greater storage stability or more concentrated solutions for more direct polyamidation. This salt solution is charged at a rate of 40.9 kg/min to the mix vessels (750, 750′). The mix vessels (750, 750′) alternate between filling and use stages to provide uninterrupted supply of balanced salt. The mix vessels (750, 750′) are maintained at above 170° C. and at least 30 psig under inert atmosphere.

In this example the mix vessels (750, 750′) are used to monitor and adjust pH. While draining one mix vessel at a rate of about 41.0 kg/min, the other vessel is in a filling and adjustment stage. After the vessel is filled, samples are collected and pH is determined by conventional means but online NIR or Raman spectroscopy are also found to be useful alternatives. Aqueous hexamethylenediamine (730) is added until balance is achieved within the desired range. It will be understood that amine-rich solids from Example 2 could also be used for this purpose either via solid addition, in molten form, or as an aqueous solution. An overall molar balance of the diacid and diamine of between 0.995 and 1.005 is achieved. Once balance is achieved, the tank is held until needed at temperature and pressure under agitation and inert atmosphere.

This process yields an aqueous solution (760) that contains about 90.0% by weight of a mixture of ionized adipic acid, ionized hexamethylenediamine and various oligomers of the two monomers. This product is then polyamidated to desirably high molecular weight in a series of sequentially used batch autoclaves. Alternatively, this configuration can be used to supply continuous polyamidation reactors.

It will be understood that piping variations as well as the number and combination of mix vessels in this example can be varied without departing from this invention. An alternative embodiment not presented utilizes only a single mix vessel after the extruder as a continuous stirred tank reactor. This is accomplished by continuously co-feeding the aqueous hexamethylenediamine at about 0.5-0.7 kg/min along with the 40.9 kg/min aqueous salt solution from the extruder. The flow rate of the aqueous hexamethylenediamine is controlled by monitoring the mix vessel effluent using online NIR. Online Raman is also an effective means of monitoring the molar balance. It is found that this provides an overall molar balance of the diacid and diamine of between 0.995 and 1.005. In another variation of this embodiment, it is found that an appropriately sized transfer line is useful when installed between the extruder and the mix vessel. In a further variation, the mix vessels are replaced altogether by an inline static mixer and a transfer line of suitable length. In an embodiment not shown, the amine-rich solid feed is replaced with a liquid feed of a amine-rich mixture melted from bulk solidification.

### Example 8

### Continuous Preparation of Salt Solutions from Amine-Rich and Acid-Rich Solids

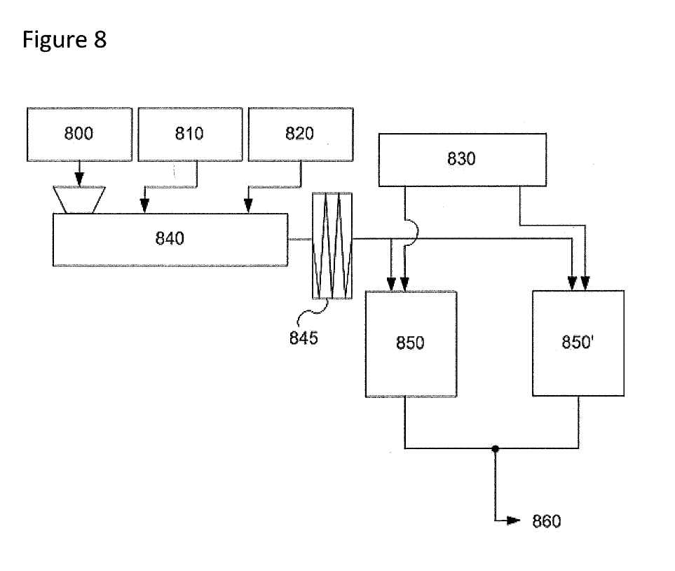

The description of this example may be better understood by reference to FIG. 8. The acid-rich pellets (800) of Example 1 are conveyed by known means at a rate of 29.5 kg/min to a single screw extruder (840) under inert atmosphere. The first stage of the extruder is operated to melt the pellets smoothly to yield a clear melt at 125° C. A pressurized liquid port is used to charge water (810) at 2.3 kg/min. The amine-rich pellets (820) of Example 2 are conveyed by known means as a melt at a rate of 20.0 kg/min via a side feeder, and in this stage the temperature is increased to 180° C. In an alternative embodiment, it is found that either pure or aqueous hexamethylenediamine may be fed via an appropriately configured liquid feeder in place of the amine-rich pellets, and in that case the flow rate is reduced to achieve the desired stoichiometric balance. The temperature is stepped up through the later stages leading to a 200° C. exit temperature. The barrel, screw and die are designed to produce final pressures above 30 psig. The extruder (840) is constructed of corrosion-resistant alloys and the screw is designed to promote mixing such that additives can be injected along the barrel as desired. In an alternative embodiment it is found that a twin screw extruder can also be configured to satisfy the requirements of this example.

In this example, a transfer line (845) is used to add 20 minutes of residence time ahead of the mix vessels. By appropriate design of the screw, adequate mixing is achieved to produce a clear aqueous salt solution. It will be understood that, without departing from this invention, the water feed in this configuration can be varied to supply more dilute salt solutions for greater storage stability or more concentrated solutions for more direct polyamidation. This salt solution is charged at a rate of 51.8 kg/min to the mix vessels (850, 850′). The mix vessels (850, 850′) alternate between filling and use stages to provide uninterrupted supply of balanced salt. The mix vessels (850, 850′) are maintained at above 180° C. and at least 30 psig under inert atmosphere.

In this example the mix vessels (850, 850′) are used to monitor and adjust pH. While draining one mix vessel at a rate of about 51.8 kg/min, the other vessel is in a filling and adjustment stage. After the vessel is filled, samples are collected and pH is determined by conventional means but online NIR or Raman spectroscopy are also found to be useful alternatives. Aqueous hexamethylenediamine (830) is added until balance is achieved within the desired range. It will be understood that amine-rich solids (820) from Example 2 could also be used for this purpose either via solid addition, in molten form, or as an aqueous solution. An overall molar balance of the diacid and diamine of between 0.995 and 1.005 is achieved. Once balance is achieved, the tank is held until needed at temperature and pressure under agitation and inert atmosphere.

This process yields an aqueous solution (860) that contains about 95.0% by weight of a mixture of ionized adipic acid, ionized hexamethylenediamine and various oligomers of the two monomers. This product is then polyamidated to desirably high molecular weight in a series of sequentially used batch autoclaves. Alternatively, this configuration can be used to supply continuous polyamidation reactors.

It will be understood that piping as well as the number and combination of mix vessels in this example can be varied without departing from this invention. An alternative embodiment not presented utilizes only a single mix vessel after the transfer line as a continuous stirred tank reactor. This is accomplished by continuously co-feeding the aqueous or anhydrous hexamethylenediamine at about 0.2-0.4 kg/min along with the 51.8 kg/min aqueous salt solution from the extruder. The flow rate of the hexamethylenediamine is controlled by monitoring the mix vessel effluent using online NIR. Online Raman is also an effective means of monitoring the molar balance. It is found that this provides an overall molar balance of the diacid and diamine of between 0.995 and 1.005. In another variation of this embodiment, the mix vessels are replaced altogether by an inline static mixer and an additional transfer line of suitable length. In an embodiment not shown, one or both of the feeds of acid-rich and amine-rich solids are replaced with liquid feeds of acid-rich and amine-rich mixtures melted from bulk solidification.

### Example 9

### Continuous Preparation of Polyamides from Acid-Rich Solids

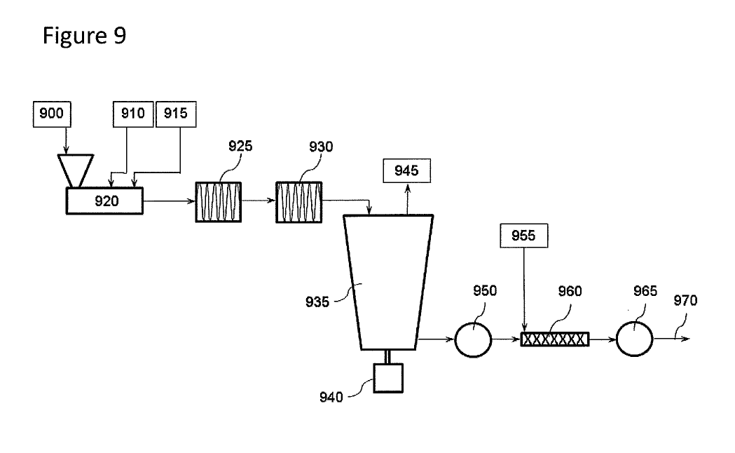

The description of this example may be better understood by reference to FIG. 9. The acid-rich pellets (900) of Example 1 are conveyed by known means at a rate of 29.5 kg/min to a single screw extruder (920) under inert atmosphere. The first stage of the extruder is operated to melt the pellets smoothly to yield a clear melt at ca. 125-140° C. Water (910) may be optionally added as an aid to processing and mixing. In some cases additives such as delustrants are desirable and these may also be fed to the extruder as part of this stream or separately. In this example water is fed continuously at a rate of 0.76 kg/min but it is also found that no water is required under some conditions. The temperature is increased along the screw such that the melt is above 180° C. at the point where a molten diamine rich stream (915) is added. This preferentially occurs in proximity to a mixing zone of the single screw extruder. In this example, 90% aqueous hexamethylenediamine is fed at 15.1 kg/min. Other concentrations may be used including neat diamine so long as it fed in a manner that mixes smoothly. In an alternative embodiment, a melt of the amine-rich solids of Example 2 is used and in yet another embodiment the amine-rich mixture is fed directly without prior solidification.

The extruder utilizes a screw designed to promote mixing and it is constructed of a corrosion resistant alloy. It will be understood that extruders of other designs and configurations may be used without departing from this invention. In an alternative embodiment not presented the acid-rich mixture is not solidified or pelletized but is instead fed as a melt directly to the extruder, and as a further alternative in that configuration the extruder may be replaced with an inline mixer such as those well known in the art. In another embodiment not presented the acid-rich solids and amine-rich solids are metered continuously and co-fed into the hopper of the extruder and melted simultaneously at higher temperature.

The extruder is operated under conditions to yield a clear melt of stable composition. In this example, temperatures of about 200° C. or higher and autogenic pressures of about 200 PSIA or higher were found to be satisfactory. The effluent of the extruder is fed to a pipe coil of constant diameter known in the art as an equalizer coil (925). This is immersed in a heat transfer fluid to maintain temperature above at least 225° C. and in this example 275-280° C. was used. The pipe is designed to maintain pressure such that little or no vapourization is observed. The equalizer is designed to achieve sufficient residence time such that the mixture approaches thermodynamic equilibrium, and in this example it was sized to provide a 20 minute residence time. It will be understood that vessels of other designs and configurations such as those well known in the art may be used to achieve adequate approach to equilibrium, and any of these may be alternatives used without departing from this invention.

The effluent of the equalizer coil is fed to a flasher (930) which is designed to let down the pressure to near atmospheric without solidification or the accumulation of build-up or gel. Any of the designs that are well known in the art may be used without departing from this invention, and in this example it is constructed of a series of pipe bends and lengths of successively increasing diameter. In this example, it is sized such that the average liquid hold-up time is approximately 20 minutes but other sizes can be used so long as solidification in the flasher is not observed and the desired pressure let-down is achieved. The flasher is immersed in a heat transfer fluid such that it is maintained at above 255° C. and in this example it is kept heated at 275-280° C.

The effluent of the flasher is fed to a finishing process. Any of the designs well known in the art may be used for finishing without departing from this invention. Under suitable conditions the flasher effluent may be separated and pelletized and then either used or built to higher molecular weights through solid phase polymerization. In this example the melt is fed to a vessel (935) designed for mechanical agitation (940) and also to allow the release of steam and vapours (945) through a control valve. It is found in this instance that stable operations are achieved when the melt finisher is kept at above 255° C. and it is kept at about 280-285° C. and between 40-50 PSIA. Maintaining residence time in the finisher at about 100-110 minutes yields a polymer that exhibits a relative viscosity (RV) 48-55 (where relative viscosity is the ratio of viscosity at 25° C. of an 8.4 percent by weight solution of polyamide in 90 percent formic acid to the viscosity at 25° C. of the 90 percent formic acid alone).

The molar balance of acid and amine groups is achieved and maintained in this example through the monitoring and adjustment of the melt finisher effluent. An NIR probe (950) in the melt stream is used to determine end-group balance. Other types of spectroscopy such as Raman may be utilized without departing from this invention. Adjustment to the molar balance is made by using the spectroscopic data in a process controller such as those well known in the art to vary a trim feed of hexamethylenediamine (955). Aqueous hexamethylenediamine may be used if the solution water is accounted for in the process definition, but in this instance anhydrous hexamethylenediamine is used. In this example the trim flow is varied between about 0.1-0.15 kg/min. The melt is mixed in this example using a static inline mixer (960) but other mixer designs are known in the art and may be used without departing from this invention. The final acid-amine molar balance of between 0.995 and 1.005 is confirmed through an additional appropriate spectroscopic measurement (965) similar to the first. The exiting pipe is designed to be of suitable length to build viscosity to a desired level and the high molecular weight polyamide is then pelletized.

### Example 10

### Continuous Preparation of Polyamide Copolymers from Amine-Rich and Acid-Rich Solids

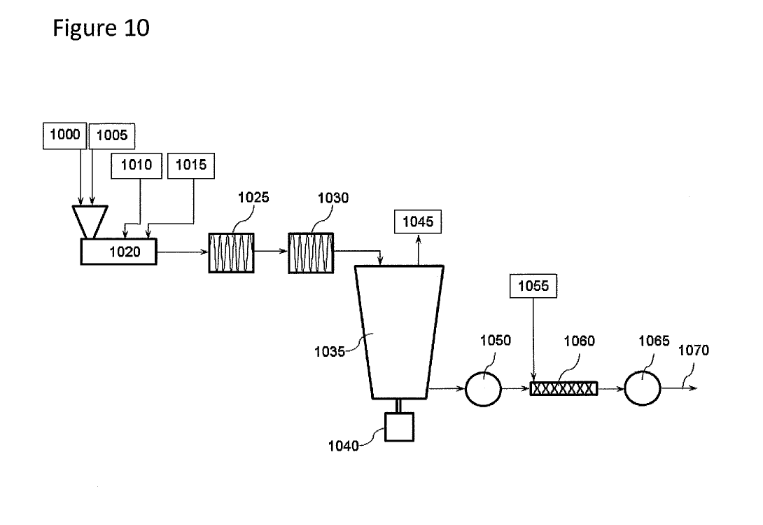

The description of this example may be better understood by reference to FIG. 10. This example uses the equipment and methods of Example 9 with the exception that an additional side feeder has been added to the extruder for the metering of an additional diacid powder. In this instance, sebacic acid (1005) is metered at 5.5 kg/min. To compensate for additional diacid the feed of the diamine rich stream is increased. In this instance metering 90% aqueous hexamethylene diamine (1015) continuously at a feed rate of 18.6 kg/min is used. With those two exceptions, using the other conditions as described in Example 9 is found to provide a balanced polyamide copolymer of usefully high molecular weight.

In an alternative embodiment, other diacids, diamines, catalysts, and additives may be fed at the extruder or in subsequent streams. The use of either the acid-rich pellets or the amine-rich pellets may optionally be replaced by preparing the mixture locally and avoiding solidification or by melting from a bulk container. The temperatures and pressures of the piping, mixer and reactor are controlled to maintain a clear melt free of solidication. Additional residence time may be obtained through the use of appropriately sized transfer lines and optionally other known finishing techniques may be used to further enhance the build of molecular weight. Other embodiments not shown are used to optionally achieve product variations of composition and molecular weight.

It is understood that the above descriptions are intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” “third,” and the like are used merely as labels, and are not intended to impose numerical requirements on their objects.

What is claimed is:

1. A process for the production of a polyamide composition from one or more solidified stoichiometrically imbalanced mixtures of diacids and diamines; the process comprising steps of:
a) forming an acid-rich solidified first component in a dry or moisture containing state by;
b) contacting at least a dicarboxylic acid with at least a diamine in a molar ratio of greater than 1:1;
c) forming an amine-rich solidified second component in a dry or moisture containing state by;
d) contacting at least a dicarboxylic acid with at least a diamine in a molar ratio of less than 1:1;
e) contacting the acid-rich first component with the amine-rich second component in a molten state or a solution state and
f) forming a first composition having a composition molar ratio
g) such that a total dicarboxylic acid content and a total diamine content, supplied by said first and second components, is from about 0.95 to about 1.05;
h) heating the first composition with agitation in the molten state and under pressure to a sufficiently high temperature for a polyamidation reaction to and subsequently,
i) forming a second composition comprising a polyamide.

2. The process of claim 1 for production of a polyamide composition from one or more solidified stoichiometrically imbalanced mixtures of diacids and diamines; includes wherein the molar ratio of the diacid to the diamine, whether free or chemically combined, in the acid-rich component is at least 1.5:1.

3. The process of claim 1 for production of a polyamide composition from one or more solidified stoichiometrically imbalanced mixtures of diacids and diamines; includes wherein the dicarboxylic acid is adipic acid and the diamine is hexamethylenediamine.

4. The process of claim 1 for production of a polyamide composition from one or more solidified stoichiometrically imbalanced mixtures of diacids and diamines; includes wherein the dicarboxylic acid includes one or more diacids selected from the group consisting of: oxalic acid, malonic acid, succinic acid, glutaric acid, pimelic acid, adipic acid, suberic acid, azelaic acid, sebacic acid, undecanedioic acid, dodecandioic acid, maleic acid, glutaconic acid, traumatic acid, and muconic acid, 1,2- or 1,3-cyclohexande dicarboxylic acids, 1,2- or 1,3-phenylenediacetic acids, 1,2- or 1,3-cyclohexane diacetic acids, isophthalic acid, terephthalic acid, 4,4′-oxybisbenzoic acid, 4,4-benzophenone dicarboxylic acid, 2,6-napthalene dicarboxylic acid, p-t-butyl isophthalic acid and 2,5-furandicarboxylic acid.

5. The process of claim 1 for production of a polyamide composition from one or more solidified stoichiometrically imbalanced mixtures of diacids and diamines; includes wherein the diamine selected from the group consisting of:
ethanoldiamine, trimethylenediamine, putrescine, cadaverine, hexamethyelenediamine, 2-methyl pentamethylenediamine, heptamethylenediamine, 2-methyl hexamethylenediamine, 3-methyl hexamethylenediamine, 2,2-dimethyl pentamethylenediamine, octamethylenediamine, 2,5-dimethyl hexamethylenediamine, nonamethylenediamine, 2,2,4- and 2,4,4-trimethyl hexamethylenediamines, decamethylenediamine, 5-methylnonanediamine, isophoronediamine, undecamethylenediamine, dodecamethylenediamine, 2,2,7,7-tetramethyl octamethylenediamine, meta-xylylene diamine, paraxylylene diamine, bis(p-aminocyclohexyl)methane, bix(aminomethyl)norbornane, any C₂-C₁₆ aliphatic diamine optionally substituted with one or more C₁ to C₄ alkyl groups, aliphatic polyether diamines and furanic diamines such as 2,5-bis(aminomethyl)furan.

6. The process of claim 1 for production of a polyamide composition from one or more solidified stoichiometrically imbalanced mixtures of diacids and diamines; includes wherein the solidified acid-rich component melts below 155° C. at atmospheric pressure.

7. The process of claim 1 for production of a polyamide composition from one or more solidified stoichiometrically imbalanced mixtures of diacids and diamines; includes wherein a granular form of the solidified acid-rich component does not fuse during storage or optionally during shipment.

8. The process of claim 1 for production of a polyamide composition from one or more solidified stoichiometrically imbalanced mixtures of diacids and diamines; includes wherein the granular form of the solidified acid-rich component flows freely.

9. The process of claim 1 for production of a polyamide composition from one or more solidified stoichiometrically imbalanced mixtures of diacids and diamines; includes wherein a bulk form of the solidified acid-rich component melts without degradation or discoloration.

10. The process of claim 1 for production of a polyamide composition from one or more solidified stoichiometrically imbalanced mixtures of diacids and diamines; includes wherein a solidified amine-rich component melts without degradation or discoloration whether it is solidified into bulk or granular form.

11. The process of claim 1 for production of a polyamide composition from one or more solidified stoichiometrically imbalanced mixtures of diacids and diamines; includes wherein a granular form of the solidified amine-rich component flows freely.

12. The process of claim 1 for production of a polyamide composition from one or more solidified stoichiometrically imbalanced mixtures of diacids and diamines; includes wherein the granular form of the solidified amine-rich component does not fuse during storage or optionally during shipment.

13. The process of claim 1 for production of a polyamide composition from one or more solidified stoichiometrically imbalanced mixtures of diacids and diamines; includes wherein the amine-rich component is hexamethylenediamine in molten form or aqueous solution.

14. The process of claim 1 for production of a polyamide composition from one or more solidified stoichiometrically imbalanced mixtures of diacids and diamines; includes wherein additional water is added to dilute the blend of the molten imbalanced mixtures.

15. The process of claim 1 for production of a polyamide composition from one or more solidified stoichiometrically imbalanced mixtures of diacids and diamines; includes wherein the amine-rich second component is contacted in a state of aqueous dilution.
